(19) United States
(12) Patent Application Publication
(10) Pub. No.: US 2014/0232484 A1
(43) Pub. Date: Aug. 21, 2014

(54) PHASE SHIFT CIRCUIT AND ANTENNA DEVICE

(71) Applicant: HITACHI METALS, LTD., Tokyo (JP)

(72) Inventors: Kazuhiro SAKASAI, Hitachi (JP); Tomoyuki OGAWA, Hitachi (JP)

(73) Assignee: HITACHI METALS, LTD., Tokyo (JP)

(21) Appl. No.: 14/081,268

(22) Filed: Nov. 15, 2013

(30) Foreign Application Priority Data
Feb. 15, 2013 (JP) 2013-28406

(51) Int. Cl. H01P 1/18

(52) U.S. Cl. CPC H01P 1/184
USPC 333/161

(57) ABSTRACT

Techniques capable of reducing the width-direction size of a phase shift circuit as much as possible are provided. A phase shift circuit has a signal line, a first dielectric plate, and a second dielectric plate. The signal line has first to third intersecting parts extending in a direction intersecting with a longitudinal direction of the phase shift circuit. On the other hand, the first dielectric plate and the second dielectric plate have first to third overlapping parts overlapping the intersecting parts of the signal line. When the first dielectric plate and the second dielectric plate are moved in the longitudinal direction of the phase shift circuit, the overlapped areas between the intersecting parts of the signal line and the overlapping parts of the first dielectric plate and the second dielectric plate are changed.

### CROSS-REFERENCE TO RELATED APPLICATION

The present application claims priority from Japanese Patent Application No. 2013-28406 filed on Feb. 15, 2013, the content of which is hereby incorporated by reference into this application.

### TECHNICAL FIELD OF THE INVENTION

The present invention relates to a phase shift circuit suitable for an antenna device.

### BACKGROUND OF THE INVENTION

Conventional phase shift circuits used in a base-station antenna are described in Japanese Patent No. 4745213 (Patent Document 1) and U.S. Pat. No. 5,940,030 (Patent Document 2).

A phase shift circuit described in Patent Document 1 includes a signal line, a ground conductor provided to be opposed to the signal line, and a dielectric plate inserted between the signal line and the ground conductor from a direction perpendicular to a longitudinal direction of the signal line. In the phase shift circuit described in Patent Document 1, the overlapped area between the dielectric plate and the signal line is changed depending on the inserted length of the dielectric plate, and thereby controls the phase of the signal output from the signal line.

Patent Document 2 describes a phase shift circuit having substantially the same configuration as the phase shift circuit described in Patent Document 1. Nevertheless, the phase shift circuit described in Patent Document 2 has a characteristic impedance of a signal line changed by inserting a dielectric plate. That is, a circuit to match impedance is also incorporated to the phase shift circuit described in Patent Document 2.

### SUMMARY OF THE INVENTION

In the phase shift circuits described in Patent Documents 1 and 2 mentioned above, the dielectric plate is inserted from the direction perpendicular to the longitudinal direction of the signal line. Therefore, the size of the phase shift circuit in the direction perpendicular to the longitudinal direction of the signal line, that is, in the width direction is increased, with the result that the width-direction size of a base-station antenna also tends to be increased.

When the width-direction size of the base-station antenna is increased, the following problems arise. For example, the wind-pressure load received by the base-station antenna is increased. Moreover, since the size of an iron tower on which the base-station antenna is installed is also increased, an installation site for the iron tower is expanded, and it becomes difficult to reserve the site.

An object of the present invention is to reduce the width-direction size of a phase shift circuit.

The present invention has been made for achieving the object mentioned above, and according to an embodiment of the present invention, a phase shift circuit for changing a phase of a signal includes: a first dielectric body and a second dielectric body opposed to each other; and a first conductor disposed between the first dielectric body and the second dielectric body. The first conductor is provided with an intersecting part extending in a direction intersecting with a longitudinal direction of the phase shift circuit. Each of the first dielectric body and the second dielectric body is provided with an overlapping part overlapping the intersecting part of the first conductor. Also, an overlapped area between the intersecting part and the overlapping part is changed as the first dielectric body and the second dielectric body are moved in the longitudinal direction of the phase shift circuit.

The present invention is capable of reducing the width-direction size of a phase shift circuit.

### BRIEF DESCRIPTIONS OF THE DRAWINGS

FIG. 1 is a schematic drawing showing an example of the configuration of a base-station antenna according to an embodiment of the present invention;

FIG. 2 is a perspective view showing an example of the structure of a phase shift circuit applied to the base-station antenna of FIG. 1;

FIG. 3 is a plan view showing an example of the structure of the phase shift circuit applied to the base-station antenna of FIG. 1;

FIG. 4 is a cross-sectional view taken along an x-x′ section line of FIG. 3;

FIG. 5A is an explanatory drawing showing an example of movement of first and second dielectric plates in a simulation using the structure of the phase shift circuit of FIG. 2 to FIG. 4;

FIG. 5B is an explanatory drawing showing an example of the movement of the first and second dielectric plates in the simulation using the structure of the phase shift circuit of FIG. 2 to FIG. 4;

FIG. 5C is an explanatory drawing showing an example of the movement of the first and second dielectric plates in the simulation using the structure of the phase shift circuit of FIG. 2 to FIG. 4;

FIG. 6 is an explanatory drawing showing an example of the relation between frequency and VSWR in the result of the simulation shown in FIG. 5A to FIG. 5C;

FIG. 7 is an explanatory drawing showing an example of the relation between frequency and phase in the result of the simulation shown in FIG. 5A to FIG. 5C; and

FIG. 8 is a plan view showing a modification example of the structure of the phase shift circuit applied to the base-station antenna of FIG. 1.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary description thereof. Also, in the embodiments described below, when referring to the number of elements (including number of pieces, values, amount, range, and the like), the number of the elements is not limited to a specific number unless otherwise stated or except the case where the number is apparently limited to a specific number in principle, and the number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

### Outline of Embodiment

First, an outline of an embodiment will be described. In the description of the outline of the present embodiment, constituent elements of the embodiment are denoted by corresponding reference numerals.

A phase shift circuit according to the present embodiment changes the phase of an input signal. The phase shift circuit according to the present embodiment has a signal line 11 serving as a first conductor and a first dielectric plate 12 and a second dielectric plate 13 serving as a first dielectric body and a second dielectric body. The first dielectric plate 12 and the second dielectric plate 13 are opposed to each other, and the signal line 11 is disposed between the first dielectric plate 12 and the second dielectric plate 13. In this case, the signal line 11 of the present embodiment has a rectangular cross section. Thus, the signal line 11 has two principal surfaces. Therefore, one of the first dielectric plate 12 and the second dielectric plate 13 opposed to each other with the signal line 11 interposed therebetween is opposed to one of the principal surfaces of the signal line 11, and the other of the first dielectric plate 12 and the second dielectric plate 13 is opposed to the other principal surface of the signal line 11. Therefore, in the following description, of the two principal surfaces of the signal line 11, the principal surface opposed to the first dielectric plate 12 is referred to as “first principal surface”, and the principal surface opposed to the second dielectric plate 13 is referred to as “second principal surface”. In other words, the dielectric plate opposed to the first principal surface of the signal line 11 is the first dielectric plate 12, and the dielectric plate opposed to the second principal surface of the signal line 11 is the second dielectric plate 13.

Furthermore, the signal line 11 includes a plurality of intersecting parts (first to third intersecting parts 11c, 11e, and 11g) extending in the direction intersecting with the longitudinal direction of the phase shift circuit. On the other hand, the first dielectric plate 12 and the second dielectric plate 13 have a plurality of overlapping parts (first to third overlapping parts 12b, 13b, 12c, 13c, 12d, and 13d) overlapping the intersecting parts of the signal line 11. When the first dielectric plate 12 and the second dielectric plate 13 are moved in the longitudinal direction of the phase shift circuit, the overlapped areas between the intersecting parts 11c, 11e, and 11g of the signal line 11 and the overlapping parts 12b, 13b, 12c, 13c, 12d, and 13d of the first dielectric plate 12 and the second dielectric plate 13 are changed.

The phase shift circuit according to the present embodiment is a phase shift circuit suitable for application to a base-station antenna as an example of an antenna device.

Hereinafter, embodiments of the present invention will be described in detail with reference to the accompanying drawings. Note that components having the same function are denoted by the same reference numerals throughout the drawings for describing the embodiments, and the repetitive description thereof will be omitted.

### Embodiment

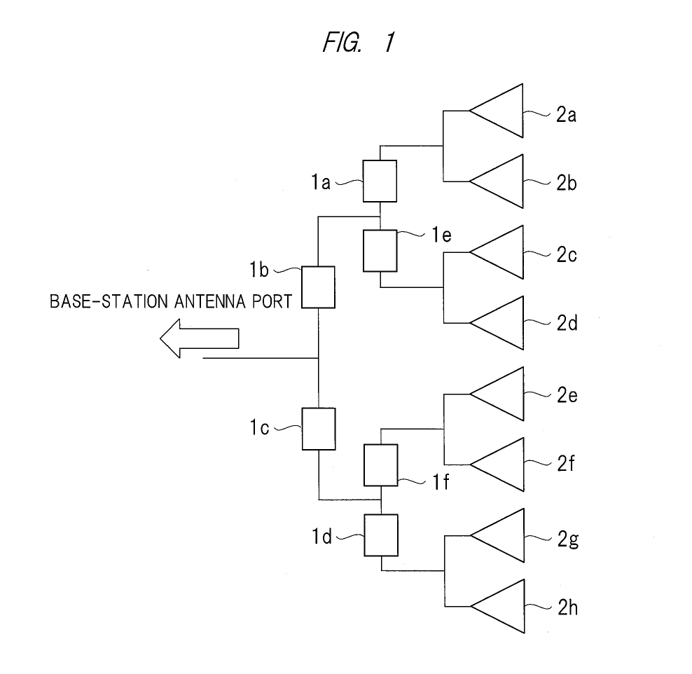

An embodiment will be described with reference to FIG. 1 to FIG. 8. In the description of the present embodiment, a base-station antenna and a phase shift circuit applied to the base-station antenna are taken as an example.

<Configuration of Base-Station Antenna>

First, a configuration of the base-station antenna according to the present embodiment will be described with reference to FIG. 1. FIG. 1 is a schematic drawing showing an example of the configuration of the base-station antenna.

As shown in FIG. 1, the base-station antenna has an input terminal (not shown) to which a high-frequency signal output from a high-frequency circuit (not shown) or the like is input, a plurality of phase shift circuits 1a to 1f (collectively referred to also as “phase shift circuits 1”), and a plurality of antenna elements 2a to 2h (collectively referred to also as “antenna elements 2”). FIG. 1 shows six phase shift circuits 1 and eight antenna elements 2 as an example, but the numbers of the phase shift circuits 1 and the antenna elements 2 are not limited to those illustrated in FIG. 1.

To the input terminal of the base-station antenna shown in FIG. 1, input sides of the second phase shift circuit 1b and the third phase shift circuit 1c are connected. In other words, the second phase shift circuit 1b and the third phase shift circuit 1c are connected in parallel with each other to the input terminal. Furthermore, to an output side of the second phase shift circuit 1b, input sides of the first phase shift circuit 1a and the fifth phase shift circuit 1e are connected in parallel with each other. Also, to an output side of the third phase shift circuit 1c, input sides of the fourth phase shift circuit 1d and the sixth phase shift circuit if are connected in parallel with each other. To an output side of the first phase shift circuit 1a, the first antenna element 2a and the second antenna element 2b are connected in parallel with each other. To an output side of the fifth phase shift circuit 1e, the third antenna element 2c and the fourth antenna element 2d are connected in parallel with each other. To an output side of the sixth phase shift circuit 1f, the fifth antenna element 2e and the sixth antenna element 2f are connected in parallel with each other. To an output side of the fourth phase shift circuit 1d, the seventh antenna element 2g and the eighth antenna element 2h are connected in parallel with each other.

The phase shift circuits 1 and the antenna elements 2 as described above are mounted inside an antenna main body having a cylindrical shape. In this case, the eight antenna elements 2 are arranged along the longitudinal direction of the antenna main body having the cylindrical shape, and the corresponding phase shift circuits 1 are connected to the arranged antenna elements 2. Then, each of the phase shift circuits 1 changes the phase of the input high-frequency signal and outputs the high-frequency signal whose phase has been changed to the corresponding antenna elements 2. Thus, the base-station antenna having predetermined directivity is realized.

For example, the first, second, and fifth phase shift circuits 1a, 1b, and 1e connected to the first to fourth antenna elements 2a to 2d disposed on an upper side of the antenna main body having the cylindrical shape advance the phase of the input high-frequency signal and output the high-frequency signal whose phase has been advanced to the first to fourth antenna elements 2a to 2d. On the other hand, the third, fourth, and sixth phase shift circuits 1c, 1d, and 1f connected to the fifth to eighth antenna elements 2e to 2h disposed on a lower side of the antenna main body retard the phase of the input high-frequency signal and output the high-frequency signal whose phase has been retarded to the fifth to eighth antenna elements 2e to 2h. As a result, a desired beam tilt angle (directivity) can be realized. Generally, since the base-station antenna is installed at a high location and mobile phones and others present therebelow are communication targets thereof, the base-station antenna has a characteristic of tilting a beam downward relative to a horizontal plane.

<Structure of Phase Shift Circuit>

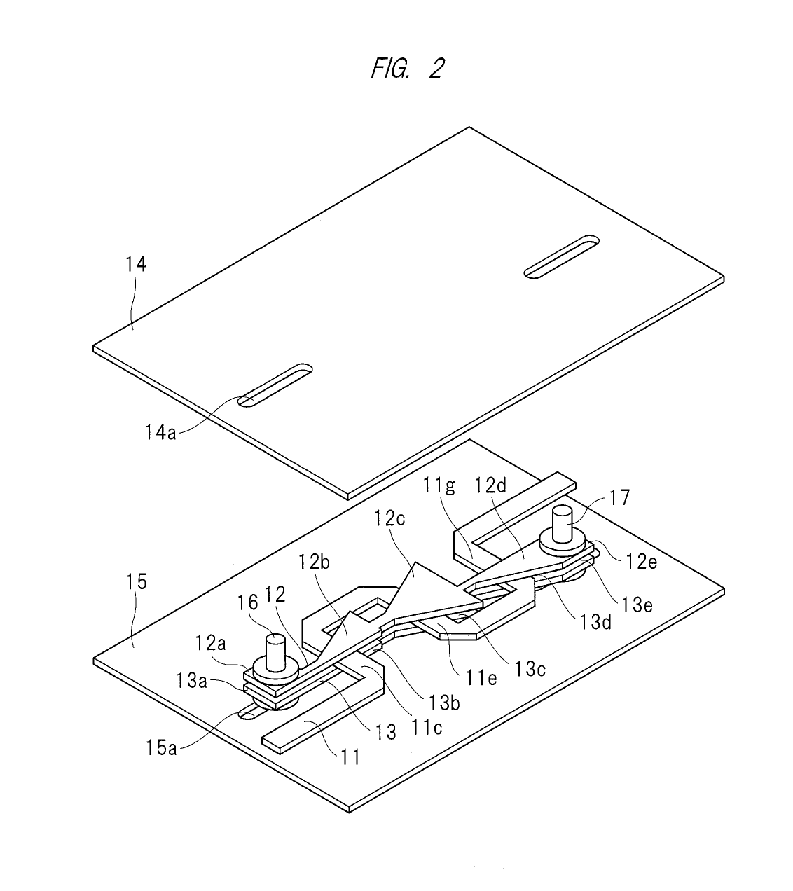

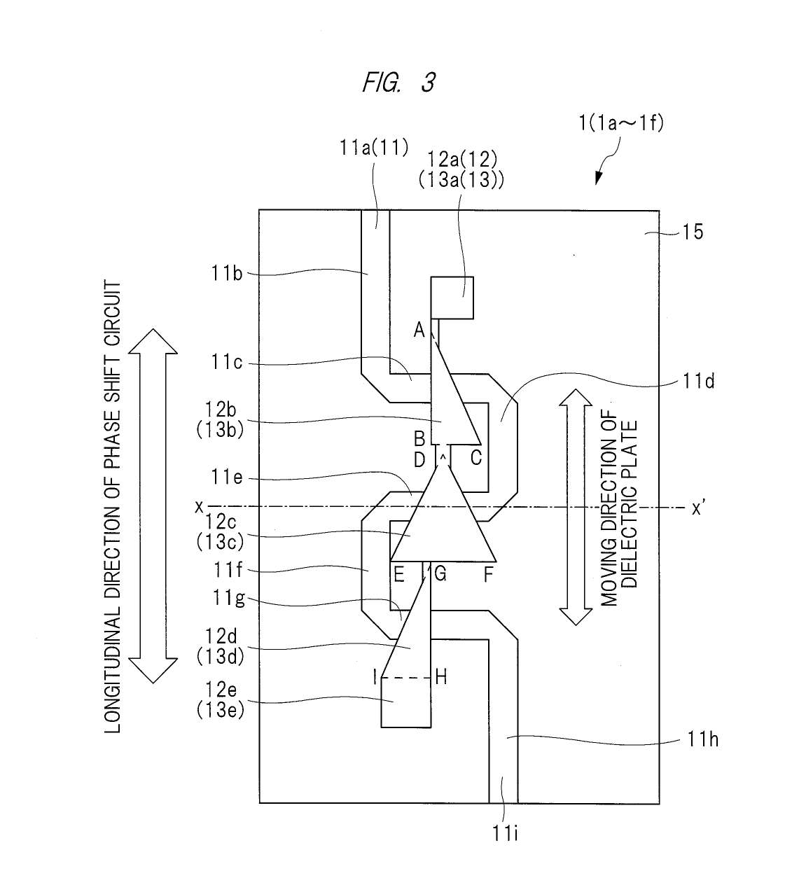

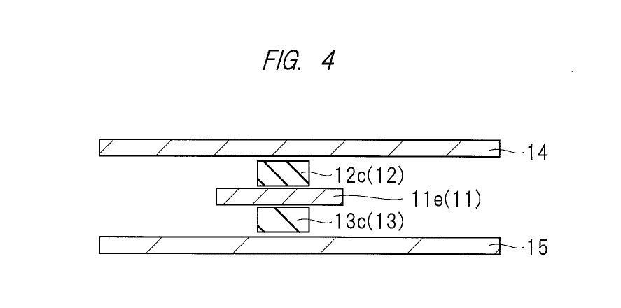

Next, the structure of the phase shift circuit 1 (1a to 1f) shown in FIG. 1 will be described with reference to FIG. 2 to FIG. 4. FIG. 2 is a perspective view showing an example of the structure of the phase shift circuit 1. FIG. 3 is a plan view showing an example of the structure of the phase shift circuit 1. FIG. 4 is a cross-sectional view taken along the x-x′ section line of FIG. 3.

The phase shift circuit 1 according to the present embodiment is a phase shift circuit capable of changing the phase of an input signal and then outputting the signal. As shown mainly in FIG. 2, the phase shift circuit 1 has a signal line 11, a first dielectric plate 12, a second dielectric plate 13, a first ground plate 14, and a second ground plate 15. The first dielectric plate 12 is disposed to be opposed to a first principal surface of the signal line 11, and the second dielectric plate 13 is disposed to be opposed to a second principal surface of the signal line 11. In the following descriptions, sometimes, the first principal surface of the signal line 11 is referred to as “front surface”, and the second principal surface is referred to as “back surface” to distinguish them from each other. As a matter of course, the distinction is merely distinction for the sake of convenience of description. The first dielectric plate 12 and the second dielectric plate 13 are integrally movable in a longitudinal direction of the phase shift circuit 1. The first ground plate 14 is disposed on the opposite side of the signal line 11 with the first dielectric plate 12 interposed therebetween, and the second ground plate 15 is disposed on the opposite side of the signal line 11 with the second dielectric plate 13 interposed therebetween. In other words, the signal line 11, the first dielectric plate 12, and the second dielectric plate 13 are disposed between the first ground plate 14 and the second ground plate 15 opposed to each other. FIG. 2 shows a state in which the first ground plate 14 on the upper surface side has been removed. Also, although the second dielectric plate 13 is hidden behind the first dielectric plate 12 and invisible in FIG. 3, the reference numerals of constituent elements of the second dielectric plate 13 are also noted and shown in parentheses.

As shown mainly in FIG. 3, the signal line 11 has a signal input end 11a disposed on one longitudinal end side of the phase shift circuit 1, a signal output end 11i disposed on the other longitudinal end side of the phase shift circuit 1, and a line connecting the signal input end 11a and the signal output end 11i to each other. On this line, a plurality of intersecting parts extending in the direction intersecting with the longitudinal direction of the phase shift circuit 1 (for example, the perpendicular direction in the present embodiment) and a plurality of connecting parts extending in the direction parallel to the longitudinal direction of the phase shift circuit 1 are provided. In other words, the line is made up of the plurality of intersecting parts and the connecting parts which mutually connect the intersecting parts. As shown in FIG. 3, the signal line 11 in the present embodiment includes a first intersecting part 11c, a second intersecting part 11e, a third intersecting part 11g, a first connecting part 11b, a second connecting part 11d, a third connecting part 11f, and a fourth connecting part 11h.

One end of the first intersecting part 11c is connected to the signal input end 11a through the first connecting part 11b. The other end of the first intersecting part 11c is connected to one end of the second intersecting part 11e through the second connecting part 11d. The other end of the second intersecting part 11e is connected to one end of the third intersecting part 11g through the third connecting part 11f. The other end of the third intersecting part 11g is connected to the signal output end 11i through the fourth connecting part 11h.

In other words, the first connecting part 11b and the first intersecting part 11c are connected in an L-shape in the planar view. The first intersecting part 11c, the second connecting part 11d, and the second intersecting part 11e are connected in a U-shape in the planar view. The second intersecting part 11e, the third connecting part 11f, and the third intersecting part 11g are connected in a U-shape in the planar view. The third intersecting part 11g and the fourth connecting part 11h are connected in an L-shape in the planar view.

Note that the L-shape includes the shapes approximately close to an L-shape in addition to an L-shape. Similarly, the U-shape includes the shapes approximately close to a U-shape in addition to a U-shape.

As described above, the signal line 11 has a line structure which is connected from the signal input end 11a to the signal output end 11i through the first connecting part 11b, the first intersecting part 11c, the second connecting part 11d, the second intersecting part 11e, the third connecting part 11f, the third intersecting part 11g, and the fourth connecting part 11h. In other words, the signal line 11 includes a line made up of the first connecting part 11b, the first intersecting part 11c, the second connecting part 11d, the second intersecting part 11e, the third connecting part 11f, the third intersecting part 11g, and the fourth connecting part 11h, which are connected in a meander shape, and two U-shaped parts are provided on the line. Outside corners of the connecting parts are chamfered.

The first dielectric plate 12 and the second dielectric plate 13 interpose the signal line 11 from the front surface side and the back surface side. In other words, the first dielectric plate 12 and the second dielectric plate 13 are disposed so as to overlap the intersecting parts of the signal line 11. More specifically, the first dielectric plate 12 is disposed on the front surface side of the signal line 11 so as to be opposed to the signal line 11 and overlap the first to third intersecting parts 11c, 11e, and 11g of the signal line 11. Also, the second dielectric plate 13 is disposed on the back surface side of the signal line 11 so as to be opposed to the signal line 11 and overlap the first to third intersecting parts 11c, 11e, and 11g of the signal line 11. Nevertheless, the signal line 11, the first dielectric plate 12, and the second dielectric plate 13 are not in contact with one another.

The first dielectric plate 12 and the second dielectric plate 13 are movable in the longitudinal direction of the phase shift circuit 1. In other words, the first dielectric plate 12 and the second dielectric plate 13 are movable in the direction perpendicular to the extending direction of the first to third intersecting parts 11c, 11e, and 11g of the signal line 11. In this case, the first dielectric plate 12 and the second dielectric plate 13 are configured so as to be mutually coupled by first supporting parts 12a and 13a which are one end parts and second supporting parts 12e and 13e which are the other end parts and be integrally moved in the same direction. Hereinafter, the second dielectric plate 13 will be also described together with the first dielectric plate 12 mainly with reference to FIG. 3.

The first and second dielectric plates 12 and 13 have first overlapping parts 12b and 13b overlapping the first intersecting part 11c, second overlapping parts 12c and 13c overlapping the second intersecting part 11e, and third overlapping parts 12d and 13d overlapping the third intersecting part 11g. Each of the first to third overlapping parts 12b, 13b, 12c, 13c, 12d, and 13d has, for example, a triangular shape or an approximately triangular shape in the planar view.

More specifically, the planar shape of each of the first overlapping parts 12b and 13b is a right triangle having vertices A, B, and C. In the following description, the side connecting the vertex A and the vertex C to each other will be referred to as a hypotenuse, the side connecting the vertex A and the vertex B to each other will be referred to as a long adjacent side, and the side connecting the vertex B and the vertex C to each other will be referred to as a short adjacent side. The planar shape of each of the second overlapping parts 12c and 13c is an isosceles triangle having vertices D, E, and F. In the following description, the side connecting the vertex E and the vertex F to each other will be referred to as a base, the side connecting the vertex D and the vertex E to each other will be referred to as a first leg, and the side connecting the vertex D and the vertex F to each other will be referred to as a second leg. The planar shape of each of the third overlapping parts 12d and 13d is a right triangle having vertices G, H, and I. In the following description, the side connecting the vertex G and the vertex I to each other will be referred to as a hypotenuse, the side connecting the vertex G and the vertex H to each other will be referred to as a long adjacent side, and the side connecting the vertex H and the vertex I to each other will be referred to as a short adjacent side.

Note that the right triangle includes the shapes approximately close to a right triangle in addition to a right triangle. Similarly, the isosceles triangle includes the shapes approximately close to an isosceles triangle in addition to an isosceles triangle. Also, with respect to the long adjacent side and the short adjacent side of the right triangle, the adjacent side having a longer length and the adjacent side having a shorter length of the two adjacent sides are referred to as the long adjacent side and the short adjacent side, respectively. Similarly, with respect to the first leg and the second leg of the isosceles triangle, one leg of the two legs is referred to as the first leg, and the other leg of the two legs is referred to as the second leg.

Furthermore, the vertices A of the first overlapping parts 12b and 13b are connected to the first supporting parts 12a and 13a. The vertices B of the first overlapping parts 12b and 13b are connected to the vertices D of the second overlapping parts 12c and 13c. Intermediate parts of the bases connecting the vertices E and the vertices F of the second overlapping parts 12c and 13c to each other are connected to the vertices G of the third overlapping parts 12d and 13d. The vertices H of the third overlapping parts 12d and 13d are connected to the second supporting parts 12e and 13e. These parts are mutually connected via coupling parts having the shapes which enable mutual coupling. For example, the first supporting parts 12a and 13a and the second supporting parts 12e and 13e have square shapes in the planar view.

Then, the first overlapping parts 12b and 13b, the second overlapping parts 12c and 13c, and the third overlapping parts 12d and 13d can be moved in the longitudinal direction of the phase shift circuit 1 by moving the first supporting parts 12a and 13a and the second supporting parts 12e and 13e of the first and second dielectric plates 12 and 13 in the longitudinal direction of the phase shift circuit 1.

Also, the first and second dielectric plates 12 and 13 have a following layout with respect to the signal line 11. The long adjacent sides connecting the vertices A and the vertices B of the first overlapping parts 12b and 13b form a right angle with the extending direction of the first intersecting part 11c. The hypotenuses connecting the vertices A and the vertices C of the first overlapping parts 12b and 13b form 65 degrees, which is a first angle equal to or less than a right angle, with the extending direction of the first intersecting part 11c. The second legs connecting the vertices D and the vertices F of the second overlapping parts 12c and 13c to each other form 65 degrees, which is a second angle equal to or less than a right angle, with the extending direction of the second intersecting part 11e. The first legs connecting the vertices D and the vertices E of the second overlapping parts 12c and 13c to each other form 65 degrees, which is a third angle equal to or less than a right angle, with the extending direction of the second intersecting part 11e. The hypotenuses connecting the vertices G and the vertices I of the third overlapping parts 12d and 13d to each other form 65 degrees, which is a fourth angle equal to or less than a right angle, with the extending direction of the third intersecting part 11g. The long adjacent sides connecting the vertices G and the vertices H of the third overlapping parts 12d and 13d to each other form a right angle with the extending direction of the third intersecting part 11g.

Note that the right angle includes the angles approximately close to 90 degrees in addition to 90 degrees. Similarly, the 65 degrees include the angles approximately close to 65 degrees in addition to 65 degrees and may be of any angle in so far as it is equal to or less than a right angle in the present embodiment.

Also, in the first and second dielectric plates 12 and 13, the long adjacent sides connecting the vertices A and the vertices B of the first overlapping parts 12b and 13b to each other and the long adjacent sides connecting the vertices G and the vertices H of the third overlapping parts 12d and 13d to each other are disposed on the same straight line. Note that the straight line includes the lines approximately close to a straight line in addition to a straight line. The layout of the long adjacent sides connecting the vertices A and the vertices B to each other and the long adjacent sides connecting the vertices G and the vertices H to each other is not limited to the straight line, but may be configured so that the adjacent sides are disposed to be parallel to each other.

As described above, the first and second dielectric plates 12 and 13 have plate-like bodies which are connected from the first supporting parts 12a and 13a to the second supporting parts 12e and 13e through the first overlapping parts 12b and 13b, the second overlapping parts 12c and 13c, and the third overlapping parts 12d and 13d.

In the phase shift circuit 1 configured in the above-described manner, when the first and second dielectric plates 12 and 13 are moved in the longitudinal direction of the phase shift circuit 1, the areas (overlapped area) in which the first to third overlapping parts 12b, 13b, 12c, 13c, 12d, and 13d of the first and second dielectric plates 12 and 13 and the first to third intersecting parts 11c, 11e, and 11g of the signal line 11 are mutually overlapped are changed, and the phase of the signal input from the signal input end 11a of the signal line 11 is controlled. More specifically, the signal whose phase has been advanced or the signal whose phase has been retarded with respect to the signal input to the signal input end 11a of the signal line 11 is output from the signal output end 11i.

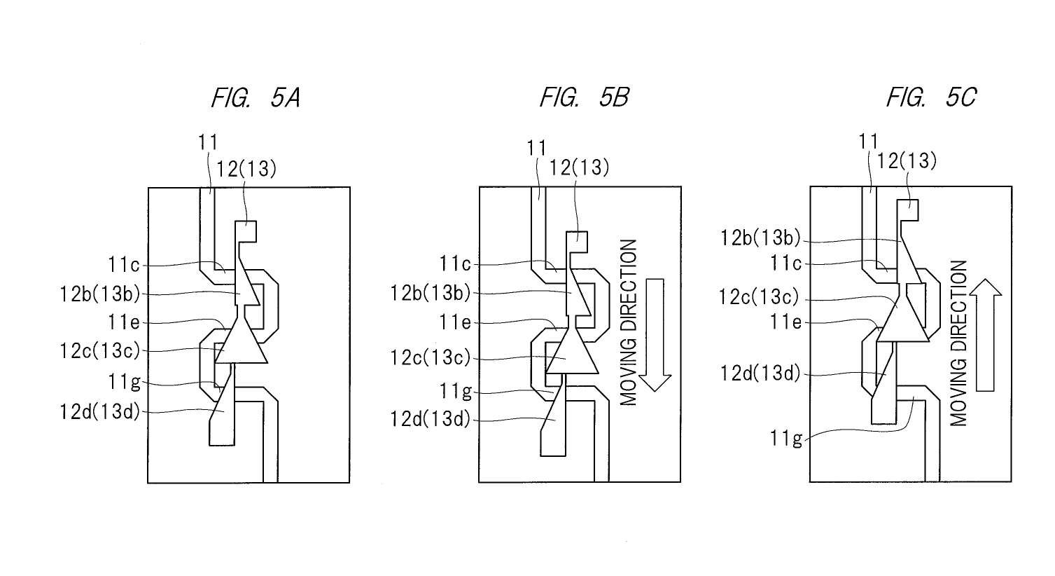

The first and second dielectric plates 12 and 13 shown in FIG. 3 are located at an intermediate position of the movable range of the first and second dielectric plates 12 and 13 (shown also in FIG. 5A). In the case of taking the intermediate position as a reference, when the first and second dielectric plates 12 and 13 are moved to a movable range end in the downward direction on the paper surface of FIG. 3, the overlapped areas between the first to third overlapping parts 12b, 13b, 12c, 13c, 12d, and 13d and the first to third intersecting parts 11c, 11e, and 11g are minimized (shown in FIG. 5B). To the contrary, when the first and second dielectric plates 12 and 13 are moved to a movable range end in the upward direction of the paper surface of FIG. 3, the overlapped areas between the first to third overlapping parts 12b, 13b, 12c, 13c, 12d, and 13d and the first to third intersecting parts 11c, 11e, and 11g are maximized (shown in FIG. 5C).

The phase shift circuit 1 shown in FIG. 2 and FIG. 3 has, for example, a cross-sectional structure as shown in FIG. 4. FIG. 4 shows a cross section of the phase shift circuit 1 taken along the x-x′ section line shown in FIG. 3. The x-x′ section line is crossing the part where the second intersecting part 11e of the signal line 11 and the second overlapping parts 12c and 13c of the first and second dielectric plates 12 and 13 are overlapped with each other. As shown in FIG. 4, in the overlapped portion, the second intersecting part 11e is interposed between the second overlapping parts 12c and 13c. Although illustration is omitted, the portion where the first intersecting part 11c and the first overlapping parts 12b and 13b are overlapped with each other and the portion where the third intersecting part 11g and the third overlapping parts 12d and 13d are overlapped with each other also have similar cross-sectional structures. More specifically, the first and third intersecting parts 11c and 11g are interposed between the first and third overlapping parts 12b, 13b, 12d, and 13d. However, as shown in FIG. 4, the second intersecting part 11e and the second overlapping parts 12c and 13c are not in contact with each other. The first intersecting part 11c and the first overlapping parts 12b and 13b are also not in contact with each other, and the third intersecting part 11g and the third overlapping parts 12d and 13d are also not in contact with each other.

In the structure of the phase shift circuit 1 described above, as a mechanism for moving the first and second dielectric plates 12 and 13 in the longitudinal direction of the phase shift circuit 1, for example, there is a mechanism described below, but this is not construed in a limiting sense. For example, in the mechanism shown in FIG. 2, the first supporting part 12a of the first dielectric plate 12 and the first supporting part 13a of the second dielectric plate 13 are coupled by a screw member 16 such as a screw rod. Similarly, the second supporting part 12e of the first dielectric plate 12 and the second supporting part 13e of the second dielectric plate 13 are coupled by a screw member 17 such as a screw rod. Furthermore, both end parts of the screw members 16 and 17 are caused to project from openings 14a and 15a provided in the first ground plate 14 and the second ground plate 15 so as to be movable along the openings 14a and 15a. Although not shown in the drawings, coupling members are coupled to projecting parts of the screw members 16 and 17 projecting from the openings 14a and 15a, screw members such as screw rods are mated with the coupling members, and the screw members are rotated by a motor or the like. By this means, the first and second dielectric plates 12 and 13 can be moved in the longitudinal direction of the phase shift circuit 1.

Also, in the structure of the phase shift circuit 1 described above, constituent elements are composed of materials described below, but these are not construed in a limiting sense. The signal line 11 is composed of a conductor and is made of, for example, a metal material such as copper. The first and second dielectric plates 12 and 13 are composed of dielectric bodies and are made of, for example, a resin material such as glass epoxy. The first and second ground plates 14 and 15 are composed of a conductor and are made of, for example, a metal material such as copper.

<Simulation Results of Phase Shift Circuit>

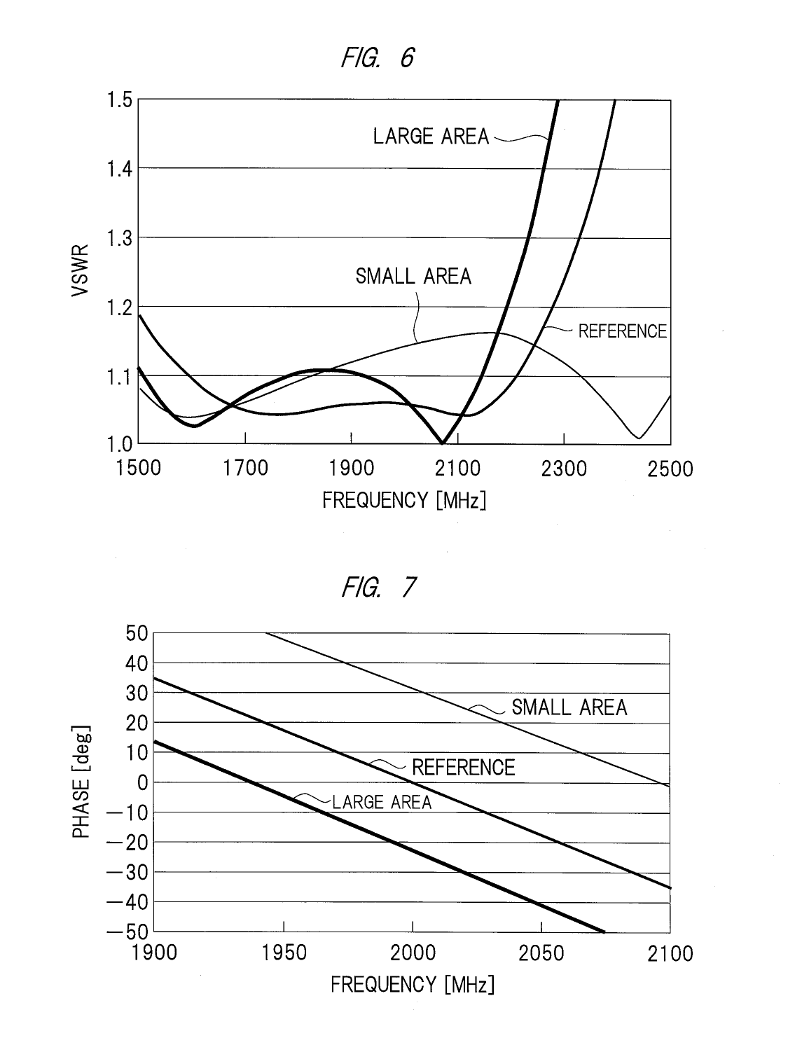

Next, the simulation using the structure of the phase shift circuit 1 (1a to 1f) shown in FIG. 2 to FIG. 4 will be described with reference to FIG. 5 to FIG. 7. FIG. 5A to FIG. 5C are explanatory drawings showing an example of movement of the first and second dielectric plates 12 and 13 in the simulation using the structure of the phase shift circuit 1. FIG. 6 is an explanatory drawing showing an example of the relation between frequency and VSWR in the result of the simulation. FIG. 7 is an explanatory drawing showing an example of the relation between frequency and phase in the result of the simulation.

The simulation using the structure of the phase shift circuit 1 can be carried out by moving the first and second dielectric plates 12 and 13 in the longitudinal direction of the phase shift circuit 1 to change the areas (overlapped areas) in which the first to third overlapping parts 12b, 13b, 12c, 13c, 12d, and 13d of the first and second dielectric plates 12 and 13 and the first to third intersecting parts 11c, 11e, and 11g of the signal line 11 are overlapped with each other.

In the simulation, the case shown in FIG. 5A, the case shown in FIG. 5B, and the case shown in FIG. 5C were measured. FIG. 5A shows the case in which the position of the first and second dielectric plates 12 and 13 is at the intermediate position of the movable range of the first and second dielectric plates 12 and 13 (referred to as a reference here). FIG. 5B shows the case in which the first and second dielectric plates 12 and 13 are moved to the movable range end in the downward direction of the paper surface of FIG. 5 and the overlapped area is the smallest (referred to as a small area here). FIG. 5C shows the case in which the first and second dielectric plates 12 and 13 are moved to the movable range end in the upward direction of the paper surface of FIG. 5 and the overlapped area is the largest (referred to as a large area here). The downward direction of the paper surface of FIG. 5 mentioned here is the direction toward the signal output end 11i in the longitudinal direction of the phase shift circuit 1. The upward direction of the paper surface of FIG. 5, which is opposite thereto, is the direction toward the signal input end 11a.

In the simulation, the signal line 11, the first and second dielectric plates 12 and 13, and the first and second ground plates 14 and 15 constituting the phase shift circuit 1 were formed under the following conditions. The distance between the first ground plate 14 and the second ground plate 15 was 5 mm. The thickness of the signal line 11 was 1 mm. The thickness of the first and second dielectric plates 12 and 13 was 2 mm. The width of the signal line 11 was 2.1 mm.

Regarding the areas in which the first and second dielectric plates 12 and 13 and the signal line 11 were overlapped with each other, the area in which the first overlapping parts 12b and 13b and the first intersecting part 11c were overlapped with each other was assumed to be a first level, the area in which the second overlapping parts 12c and 13c and the second intersecting part 11e were overlapped with each other was assumed to be a second level, the area in which the third overlapping parts 12d and 13d and the third intersecting part 11g were overlapped with each other was assumed to be a third level, and the following conditions were employed. That is, in the case of the reference, the first level was 7.7 mm², the second level was 16.3 mm², and the third level was 7.7 mm², so that the area was 31.7 mm² in total. In the case of the small area, the first level was 2.4 mm², the second level was 3.7 mm², and the third level was 2.4 mm², so that the area was 8.5 mm² in total. In the case of the large area, the first level was 13.4 mm², the second level was 29.1 mm², and the third level was 13.4 mm², so that the area was 55.9 mm² in total.

Under the conditions of the simulation described above, the result as shown in FIG. 6 was acquired as the relation between the frequency and VSWR, and the result as shown in FIG. 7 was acquired as the relation between the frequency and phase.

In FIG. 6, the horizontal axis represents the frequency [MHz], and the vertical axis represents VSWR (Voltage Standing Wave Ratio). The simulation was carried out in a frequency range of 1500 MHz to 2500 MHz.

In the case of the reference, VSWR was 1.19 at a frequency of 1500 MHz, VSWR was reduced to 1.1 and 1.05 as the frequency was increased to 1600 MHz and 1700 MHz, and VSWR was reduced to 1.04 at a frequency of 1750 MHz. Then, VSWR was increased to 1.05 as the frequency was increased to 1900 MHz, and VSWR was increased to 1.06 at a frequency of 1950 MHz. Then, VSWR was reduced to 1.05 as the frequency was increased to 2100 MHz, and VSWR was reduced to 1.04 at a frequency of 2130 MHz. Then, VSWR was increased to 1.24 as the frequency was increased to 2300 MHz, and VSWR was increased as the frequency was further increased.

As described above, in the case of the reference, the relation between the frequency and VSWR had an approximately W-shaped characteristic, and VSWR was minimized to 1.04 at the frequencies of 1750 MHz and 2130 MHz. In the case of the reference, VSWR was 1.2 or less in the frequency band of 1500 MHz to 2250 MHz.

In the case of the small area, VSWR was 1.08 at a frequency of 1500 MHz, and VSWR was reduced to 1.04 at an increased frequency of 1600 MHz. Then, VSWR was increased to 1.06, 1.12, and 1.16 as the frequency was increased to 1700 MHz, 1900 MHz, and 2100 MHz, and VSWR was increased to 1.17 at a frequency of 2150 MHz. Then, VSWR was reduced to 1.12 as the frequency was increased to 2300 MHz, and VSWR was reduced to 1.0 at a frequency of 2438 MHz. Then, VSWR was increased to 1.08 when the frequency was increased to 2500 MHz.

As described above, in the case of the small area, the relation between the frequency and VSWR had an approximately W-shaped characteristic, VSWR was 1.0 at a frequency of 2438 MHz, and this 2438 MHz was a resonance frequency. Also, VSWR was 1.04 at a frequency of 1600 MHz. In the case of the small area, VSWR was 1.2 or less in the frequency band of 1500 MHz to 2500 MHz.

In the case of the large area, VSWR was 1.11 at a frequency of 1500 MHz, and VSWR was reduced to 1.03 at an increased frequency of 1600 MHz. Then, VSWR was increased to 1.06 as the frequency was increased to 1700 MHz, and VSWR was increased to 1.11 at a frequency of 1850 MHz. Then, VSWR was reduced to 1.1 as the frequency was increased to 1900 MHz, and VSWR was reduced to 1.0 at a frequency of 2070 MHz. Then, VSWR was increased to 1.03 and 1.24 as the frequency was increased to 2100 MHz and 2200 MHz, and VSWR was increased as the frequency was further increased.

As described above, in the case of the large area, the relation between the frequency and VSWR had an approximately W-shaped characteristic, VSWR was 1.0 at a frequency of 2070 MHz, and this 2070 MHz was a resonance frequency. Also, VSWR was 1.03 at a frequency of 1600 MHz. In the case of the large area, VSWR was 1.2 or less in the frequency band of 1500 MHz to 2100 MHz.

As described above, in the simulation result shown in FIG. 6, in the relation between the frequency and VSWR, in the frequency band of 1500 MHz to 2500 MHz, a resonance point at which VSWR was 1.0 was obtained at a frequency of 2438 MHz in the case of the small area, and a resonance point at which VSWR was 1.0 was obtained at a frequency of 2070 MHz in the case of the large area. As a result, it was found out that the phase shift circuit 1 had the resonance points at the frequencies of 2438 MHz and 2070 MHz. Also, it was found out that VSWR was 1.0 at the resonance points, and the phase shift circuit 1 was proved to be well matched also in terms of impedance matching.

At the resonance points, the influence of reflective waves to traveling waves of the signal input from the signal input end 11a and output from the signal output end 11i is minimized. For example, in FIG. 3, the position of the legs connecting the vertices D and the vertices F of the second overlapping parts 12c and 13c overlapping the second intersecting part 11e is a reflecting point of the reflective waves to the traveling waves, and the position of the hypotenuses connecting the vertices G and the vertices I of the third overlapping parts 12d and 13d overlapping the third intersecting part 11g is a reflecting point of the reflective waves to the traveling waves. The frequencies of the resonance points serve as the working frequencies of the phase shift circuit 1.

The simulation result as shown in FIG. 7 was acquired as the relation between the frequency and phase. In FIG. 7, the horizontal axis represents the frequency [MHz], and the vertical axis represents the phase [deg]. The simulation was carried out in a frequency range of 1900 MHz to 2100 MHz.

In the case of the reference, the relation between the frequency and phase was as follows. That is, the phase was +35 deg. at 1900 MHz, +17 deg. at 1950 MHz, 0 deg. at 2000 MHz, −18 deg. at 2050 MHz, and −34 deg. at 2100 MHz.

In the case of the small area, the relation between the frequency and phase was as follows. That is, the phase was +47 deg. at 1950 MHz, +32 deg. at 2000 MHz, +15 deg. at 2050 MHz, and 0 deg. at 2100 MHz.

In the case of the large area, the relation between the frequency and phase was as follows. That is, the phase was +13 deg. at 1900 MHz, −5 deg. at 1950 MHz, −23 deg. at 2000 MHz, and −41 deg. at 2050 MHz.

As described above, it was found out that, in any of the case of the reference, the case of the small area, and the case of the large area, in the relation between the frequency and phase, the phase was linearly changed from +phase to −phase, that is, from an advancing direction to a retarding direction as the frequency was increased in the frequency band of 1900 MHz to 2100 MHz.

Furthermore, in the relation between the frequency and phase, as shown in FIG. 7, when the phase in the case of the reference was 0 at a frequency of 2000 MHz, the phase in the case of the small area was +32 deg., and the phase in the case of the large area was −23 deg. The phase differences between the case of the reference, the case of the small area, and the case of the large area were constant also in the frequency range of 1900 MHz to 2100 MHz.

As described above, from the relation between the frequency and phase in the simulation result shown in FIG. 7, the phase shift circuit 1 was proved to have a characteristic of advancing the phase by 32 deg. in the case of the small area and retarding the phase by 23 deg. in the case of the large area with respect to the case of the reference.

### Effects of Embodiment

According to the phase shift circuit 1 (1a to 1f) applied to the base-station antenna of the present embodiment described above, the phase shift circuit 1 has the signal line 11, the first dielectric plate 12, and the second dielectric plate 13. The signal line 11 has the first to third intersecting parts 11c, 11e, and 11g extending in the direction intersecting with the longitudinal direction of the phase shift circuit. On the other hand, the first dielectric plate 12 and the second dielectric plate 13 have the first to third overlapping parts 12b, 13b, 12c, 13c, 12d, and 13d overlapping the intersecting parts of the signal line 11. When the first dielectric plate 12 and the second dielectric plate 13 are moved in the longitudinal direction of the phase shift circuit, the overlapped areas between the intersecting parts 11c, 11e, and 11g of the signal line 11 and the overlapping parts 12b, 13b, 12c, 13c, 12d, and 13d of the first dielectric plate 12 and the second dielectric plate 13 are changed. By this means, instead of the structure in which the first and second dielectric plates 12 and 13 are inserted from the width direction of the phase shift circuit 1 like conventional cases, the structure in which the dielectric plates 12 and 13 are moved in the longitudinal direction of the phase shift circuit 1 can be employed. Therefore, the width-direction size of the phase shift circuit 1 can be reduced as much as possible. Consequently, the width-direction size of the base-station antenna can be also reduced. As a result, downsizing of the base-station antenna can be achieved. The downsizing of the base-station antenna can contribute to reduction in the cost of the base-station antenna.

Also, since the first and second dielectric plates 12 and 13 are configured to be moved in the longitudinal direction of the phase shift circuit 1, the moving mechanism of the first and second dielectric plates 12 and 13 can be simplified compared with the conventional configuration in which they are moved in the width direction of the phase shift circuit 1. More specifically, since the first and second dielectric plates 12 and 13 can be moved along the openings 14a and 15a provided in the first and second ground plates 14 and 15 by causing the both end parts of the screw members 16 and 17 coupled to the first and second dielectric plates 12 and 13 to project from the openings 14a and 15a, the moving mechanism of the first and second dielectric plates 12 and 13 can be formed with a simple configuration.

Moreover, the overlapped areas between the first to third overlapping parts 12b, 13b, 12c, 13c, 12d, and 13d of the first and second dielectric plates 12 and 13 and the first to third intersecting parts 11c, 11e, and 11g of the signal line 11 are changed by moving the first and second dielectric plates 12 and 13 in the longitudinal direction of the phase shift circuit 1. Therefore, the phase shift circuit 1 capable of setting a desired resonance frequency in the relation between the frequency and VSWR can be realized, and the phase shift circuit 1 capable of setting a desired phase difference in the relation between the frequency and phase can be realized.

Furthermore, according to the present embodiment, the following effects can be obtained.

(1) The first and second dielectric plates 12 and 13 are composed by the combinations of the first overlapping parts 12b and 13b having the right triangular shapes, the second overlapping parts 12c and 13c having the isosceles triangular shapes, and the third overlapping parts 12d and 13d having the right triangular shapes. Therefore, the overlapped area with the first to third intersecting parts 11c, 11e, and 11g of the signal line 11 can be set in a wide range from the small area to the large area.

(2) The hypotenuses of the first overlapping parts 12b and 13b, the legs of the second overlapping parts 12c and 13c, and the hypotenuses of the third overlapping parts 12d and 13d are designed to form angles equal to or less than a right angle with respect to the extending direction of the first to third intersecting parts 11c, 11e, and 11g. Therefore, two resonance frequencies can be set while using the positions of the legs of the second overlapping parts 12c and 13c and the positions of the hypotenuses of the third overlapping parts 12d and 13d as reflecting points of reflective waves with respect to traveling waves.

### Modification Examples of Embodiment

The following modification examples are conceivable for the phase shift circuits 1 (1a to 1f) applied to the base-station antenna according to the above-described present embodiment.

(1) FIG. 2 and others show the example in which the first intersecting part 11c and the second intersecting part 11e are connected through the second connecting part 11d in a U-shape and the second intersecting part 11e and the third intersecting part 11g are connected through the third connecting part 11f in a U-shape, so that the two U-shaped parts are present (two resonance points of frequencies are present). However, any number of the U-shaped parts may be provided. For example, the invention can be applied also to the case in which the number of the U-shaped parts is one, three, or more. If the number of the U-shaped parts is one, one resonance point of frequencies is present. Also in such a configuration, effects of reducing the width-direction size of the phase shift circuit as much as possible and others can be obtained like the above-described embodiment.

(2) FIG. 2 and others show the example in which the first overlapping parts 12b and 13b have the right triangular shapes, the second overlapping parts 12c and 13c have the isosceles triangular shapes, and the third overlapping parts 12d and 13d have right triangular shapes. However, the overlapping parts may have any shapes as long as overlapped areas are changed when the first and second dielectric plates 12 and 13 are moved. Particularly, it is desired that the areas be linearly changed. For example, the invention can be also applied to all triangles other than right triangles and isosceles triangles and to other shapes. Also in such a configuration, effects of reducing the width-direction size of the phase shift circuit as much as possible and others can be obtained like the above-described embodiment.

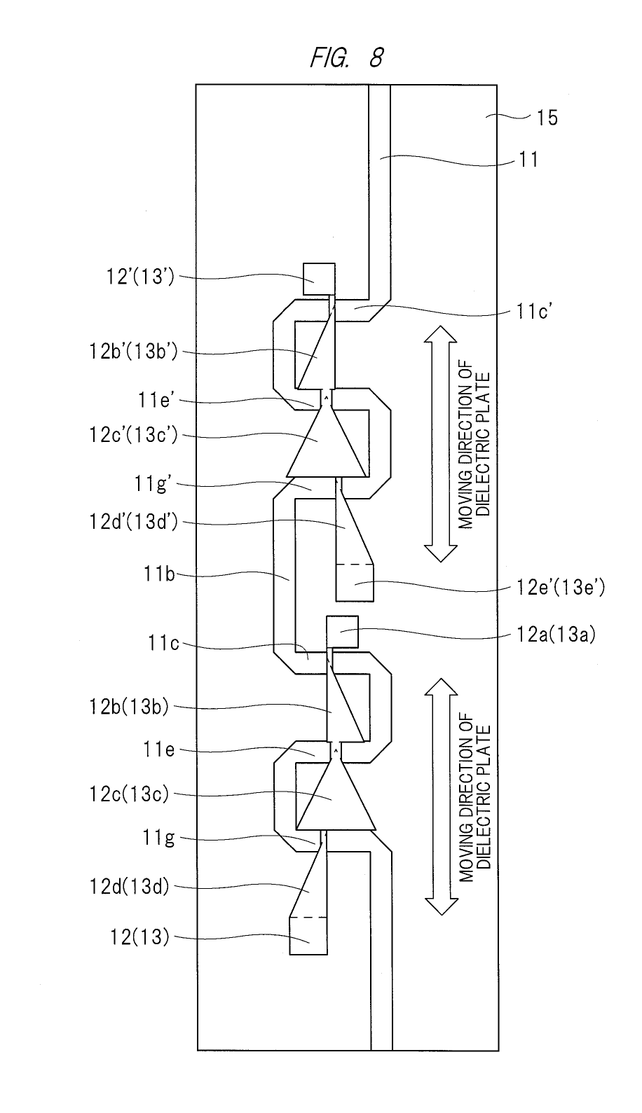

(3) FIG. 2 and others show the configuration in which the first and second dielectric plates 12 and 13 and the first to third intersecting parts 11c, 11e, and 11g are overlapped with each other. Alternatively, for example, one set of the first and second dielectric plates 12 and 13 and the first to third intersecting parts 11c, 11e, and 11g and another set of those having the same shapes may be disposed in series as shown in FIG. 8. FIG. 8 is a plan view showing a modification example of the structure of the phase shift circuit. Although FIG. 8 shows the example in which two sets of the configuration are disposed in series, it goes without saying that the invention can be applied also to the example in which three or more sets thereof are disposed.

FIG. 8 shows the configuration in which the first and second dielectric plates 12′ and 13′ disposed on the upper side of the paper surface of FIG. 8 and the first and second dielectric plates 12 and 13 disposed on the lower side of the paper surface of FIG. 8 are directed to opposite sides in the left/right direction because of a meander shape of the signal line 11. The first and second dielectric plates 12 and 13 disposed on the lower side have the same structure as FIG. 2 and others of the above-described embodiment. The configuration applied to such a case is as follows.

In the configuration of FIG. 8, when the first and second dielectric plates 12 and 13 are moved on the front surface and back surface of the signal line 11, the first and second dielectric plates 12′ and 13′ are moved in the same movable range in the same direction of the longitudinal direction of the phase shift circuit. The configuration and effects of the embodiment are the same as those of the embodiment described above in FIG. 2 and others. The line length of the first connecting part 11b connecting a third intersecting part 11g′ and the first intersecting part 11c to each other needs to be equal to or longer than a length capable of forming second supporting parts 12e′ and 13e′ of the first and second dielectric plates 12′ and 13′ and the first supporting parts 12a and 13a of the first and second dielectric plates 12 and 13.

More specifically, in the configuration shown in FIG. 8, the signal line 11 has a plurality of conductor forming parts, which are mutually coupled. The plurality of conductor forming parts have first intersecting parts 11c and 11c′, second intersecting parts 11e and 11e′, and third intersecting parts 11g and 11g′. Also, the first and second dielectric plates 12, 12′, 13, and 13′ have a plurality of dielectric forming parts, which are movable in synchronization with each other. The plurality of dielectric forming parts have first overlapping parts 12b, 12b′, 13b, and 13b′, second overlapping parts 12c, 12c′, 13c, and 13c′, and third overlapping parts 12d, 12d′, 13d, and 13d′.

More specific configurations and shapes such as U-shapes, triangles, right triangles, and isosceles triangles are the same as those of the above-described embodiment, the modification examples of (1) and (2) described above and others.

Also in such a configuration, effects of reducing the width-direction size of the phase shift circuit as much as possible and others can be obtained like the above-described embodiment.

In the foregoing, the invention made by the inventors of the present invention has been concretely described based on the embodiment. However, it is needless to say that the present invention is not limited to the foregoing embodiment and various modifications and alterations can be made within the scope of the present invention.

What is claimed is:

1. A phase shift circuit for changing a phase of a signal comprising:
a first dielectric body and a second dielectric body opposed to each other; and
a first conductor disposed between the first dielectric body and the second dielectric body,
wherein the first conductor is provided with an intersecting part extending in a direction intersecting with a longitudinal direction of the phase shift circuit,
each of the first dielectric body and the second dielectric body is provided with an overlapping part overlapping the intersecting part of the first conductor, and
an overlapped area between the intersecting part and the overlapping part is changed as the first dielectric body and the second dielectric body are moved in the longitudinal direction of the phase shift circuit.

2. The phase shift circuit according to claim 1,
wherein the first conductor is provided with a plurality of said intersecting parts,
each of the first dielectric body and the second dielectric body is provided with a plurality of said overlapping parts corresponding to the plurality of intersecting parts, and
the overlapped areas between the plurality of intersecting parts and the plurality of overlapping parts are changed as the first dielectric body and the second dielectric body are moved in the longitudinal direction of the phase shift circuit.

3. The phase shift circuit according to claim 1,
wherein the first dielectric body is disposed to be opposed to a first principal surface of the first conductor, and
the second dielectric body is disposed to be opposed to a second principal surface of the first conductor on an opposite side of the first principal surface.

4. The phase shift circuit according to claim 3,
wherein the first conductor has, as the plurality of intersecting parts, first to third intersecting parts mutually coupled via connecting parts extending in the longitudinal direction of the phase shift circuit, and
each of the first dielectric body and the second dielectric body has, as the plurality of overlapping parts, first to third overlapping parts respectively overlapping the first to third intersecting parts.

5. The phase shift circuit according to claim 4,
wherein one end of the first intersecting part is connected to an input end of the signal via a first connecting part,
one end of the second intersecting part is connected to the other end of the first intersecting part via a second connecting part,
one end of the third intersecting part is connected to the other end of the second intersecting part via a third connecting part,
the other end of the third intersecting part is connected to an output end of the signal via a fourth connecting part,
one end of the first overlapping part is connected to a first supporting part,
one end of the second overlapping part is connected to the other end of the first overlapping part,
one end of the third overlapping part is connected to the other end of the second overlapping part,
the other end of the third overlapping part is connected to a second supporting part, and
the first supporting part and the second supporting part are coupled to each other between the first dielectric body and the second dielectric body.

6. The phase shift circuit according to claim 5,
wherein the first to third overlapping parts respectively have shapes with which the overlapped areas with the first to third intersecting parts are changed as the first dielectric body and the second dielectric body are moved in the longitudinal direction of the phase shift circuit, and
the shapes include a triangular shape.

7. The phase shift circuit according to claim 6,
wherein the first overlapping part has a shape of a right triangle,
the second overlapping part has a shape of an isosceles triangle,
the third overlapping part has a shape of a right triangle,
a hypotenuse of the right triangle of the first overlapping part forms a first angle, which is equal to or less than a right angle, with an extending direction of the first intersecting part,
a first leg and a second leg of the isosceles triangle of the second overlapping part respectively form a second angle and a third angle, which are equal to or less than a right angle, with an extending direction of the second intersecting part, and
a hypotenuse of the right triangle of the third overlapping part forms a fourth angle, which is equal to or less than a right angle, with an extending direction of the third intersecting part.

8. The phase shift circuit according to claim 2,
wherein the first conductor has a plurality of mutually coupled conductor forming parts,
the plurality of conductor forming parts have the plurality of intersecting parts, respectively,
each of the first dielectric body and the second dielectric body has a plurality of dielectric forming parts which are movable in synchronization with each other, and
the plurality of dielectric forming parts have the plurality of overlapping parts, respectively.

9. The phase shift circuit according to claim 1, further comprising:
a second conductor and a third conductor of ground plates respectively disposed to be opposed to surfaces of the first dielectric body and the second dielectric body, the surfaces being on opposite sides of the first conductor.

10. An antenna device comprising:
a phase shift circuit for changing a phase of a signal,
the phase shift circuit including:
a first dielectric body and a second dielectric body opposed to each other; and
a first conductor disposed between the first dielectric body and the second dielectric body,
wherein the first conductor is provided with an intersecting part extending in a direction intersecting with a longitudinal direction of the phase shift circuit,
each of the first dielectric body and the second dielectric body is provided with an overlapping part overlapping the intersecting part of the first conductor, and
an overlapped area between the intersecting part and the overlapping part is changed as the first dielectric body and the second dielectric body are moved in the longitudinal direction of the phase shift circuit.
